(19) United States
(12) Patent Application Publication
(10) Pub. No.: US 2020/0168067 A1
(43) Pub. Date: May 28, 2020

(54) ARTICLE MANAGEMENT SYSTEM

(71) Applicant: TOSHIBA TEC KABUSHIKI KAISHA, Tokyo (JP)

(72) Inventor: Akira TAKAHASHI, Yokohama Kanagawa (JP)

(21) Appl. No.: 16/655,934

(22) Filed: Oct. 17, 2019

(30) Foreign Application Priority Data
Nov. 27, 2018 (JP) 2018-221636

(51) Int. Cl. G08B 13/24; H04W 4/80; G06Q 10/08; G06Q 30/02

(52) U.S. Cl. CPC G08B 13/2462; G08B 13/2457; G06Q 30/0282; G06Q 10/087; H04W 4/80

(57) ABSTRACT

A management system includes a terminal with a controller, a wireless tag reader to read wireless tag IDs on items being managed. The controller updates state information indicating whether an item has been checked out by a user based on the reading. The controller receives a designation of a work type from the user and extracts a corresponding item listing. The item listing is displayed, and the user is instructed to gather corresponding items and use the reader to read the wireless tags of the items. The item information for for any item associated with wireless tags read by the reader is updated to indicate the items are checked out or returned as appropriate. When at least one item from the item listing has not been checked out or returned by the user the user is instructed to remedy the shortage.

### CROSS-REFERENCE TO RELATED APPLICATION

This application is based upon and claims the benefit of priority from Japanese Patent Application No. 2018-221636, filed in Nov. 27, 2018, the entire contents of which are incorporated herein by reference.

### FIELD

Embodiments described herein relate generally to an article management system.

### BACKGROUND

A service can be provided in which an engineer or maintenance technician travels to a worksite from a central office or location to perform maintenance on an apparatus at the worksite. When going out to perform such work, the engineer/technician may carry various items or articles such as tools or replacement components for the apparatus. These items are generally stored at the central office/location until needed. However, in some instances, the engineer/technician may incorrectly estimate the number or type of items required at the worksite to complete the maintenance work. Also, in some instances, the engineer/technician may, intentionally or unintentionally, leave items or tools at the worksite upon leaving the worksite to return the central office/location.

To avoid or limit such problems, it is common for the engineer/technician to refer to a memorandum (checklist) listing the items and tools expected to be necessary at the worksite in gathering the articles/items suitable for completing the scheduled work. The memorandum can be prepared beforehand according to knowledge and experience. However, such a detailed method makes it complicated to prepare for leaving the central office/location and similarly when returning to the central office/location from the worksite. In particular, if there are a larger number of articles to be considered/checked, it is more likely that the engineer/technician will leaves an article/item behind.

The references JP-A-2006-139793, JP-A-2006-252364, and JP-A-2006-107161 propose systems for the management of tools and the like. However, existing solutions are often unsuitable for use at non-centralized locations or at the maintence worksite itself. There is a demand for systems suitable for operations at the worksite.

### DESCRIPTION OF THE DRAWINGS

FIG. 1 depicts an article management system according to an embodiment.

FIG. 2 depicts a reading of an article.

FIG. 3 illustrates configurations of a terminal and a server.

FIG. 4 depicts content of work data in an example.

FIG. 5 depicts content of article data in an example.

FIG. 6 depicts content of feedback work data in an example.

FIG. 7 depicts content of feedback article data in an example.

FIG. 8 is a flowchart illustrating work preparation processing.

FIG. 9 is a flowchart illustrating return and recording processing.

### DETAILED DESCRIPTION

An example embodiment improves efficiency in the management of articles/items carried from a base (central location) and used in work performed at a worksite (offsite location).

According to one embodiment, an item management system comprises a user terminal including a controller; a reader connected to the user terminal and configured to read ID information from a wireless tag and supply the ID information to the user terminal; and a storage unit. The storage unit stores item information in association with ID information of wireless tags on items being managed, and an item listing for a work type. The controller is configured to: store the ID information read from the wireless tag in the storage unit, the ID information being associated with an item to which the wireless tag is attached, and then update state information indicating whether the item is at a predetermined storage place or has been checked out by a user; receive a designation of a work type from the user; extract, from the storage unit, the item listing corresponding to the designated work type; control a display to display information corresponding to the extracted item listing and an instruction to the user to use the reader to read wireless tags attached to items in the extracted item listing; update the item information in the storage unit for any item associated with ID information from wireless tags read by the reader to indicate the items are checked out or returned; and indicate, via the display, that at least one item from the extracted item listing has not been checked out or returned by the user by reference to the ID information read by the reader.

An example embodiment is explained below with reference to the drawings.

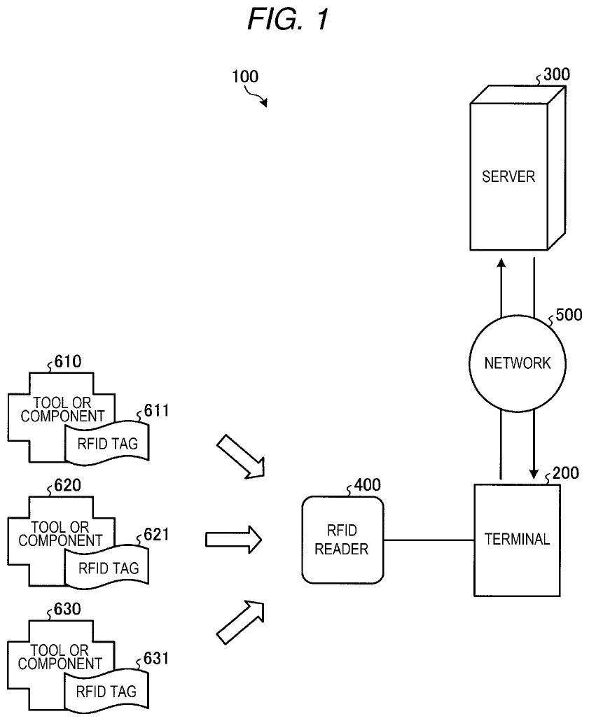

FIG. 1 is a diagram illustrating the configuration of an article management system 100 according to an embodiment. The article management system 100 is used for management of articles used by a service engineer who performs maintenance on, and who otherwise services, various apparatuses located at various worksites or locations. In general, the service engineer travels to the worksite from a central location (base). The article management system 100 includes a terminal 200, a server 300, and an RFID reader 400.

The terminal 200 is, for example, a PC (Personal Computer) and is operated by the engineer. The terminal 200 provides various user interfaces (UIs) for operations related to various functional sections included in the article management system 100.

In this example, the terminal 200 may be operated by more than one engineer. Thus, in a starting operation of the terminal 200, an engineer logs in to the terminal 200 with, for example, a user ID and a password. As the user ID, for example, an employee number may be used. If the employee number can be electronically read from an employee ID card with an electronic card reader of a corresponding type, the engineer may log in to the terminal 200 by the reading of the employee ID card by the reader.

Items 610, 620, and 630 are tools or components to be used by the engineer on a service call or maintence visit. These items 610, 620, and 630 may also be referred to as articles. RFID tags 611, 621, and 631 are wireless tags. The RFID tags 611, 621, and 631 accompany (e.g., are attached to) the items 610, 620, and 630, respectively. In this context, RFID is the abbreviation of radio frequency identification.

The server 300 stores various data used by the article management system 100 and provides data to the terminal 200. The RFID reader 400 is an example of a reader that reads information stored in a wireless tag. The RFID reader 400 reads the ID information stored in the RFID tags 611, 621, and 631 and outputs this ID information to the terminal 200. Among the various data stored by the server 300, a user ID of the user presently logged in to the terminal 200 can be used as information for specifying the updater of any data stored in the server 300.

The server 300 and the terminal 200 are capable of communicating via a network 500. The network 500 is, for example, the Internet or a LAN (Local Area Network).

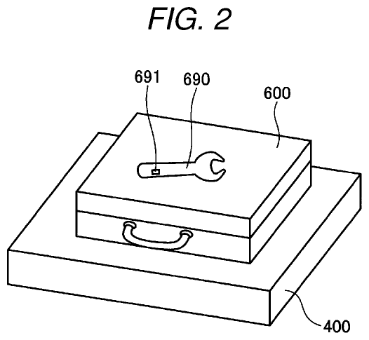

FIG. 2 is a perspective view illustrating a reading of a toolbox 600. The items 610, 620, and 630 are stored inside the toolbox 600.

An engineer about to leave the central office to visit a worksite with a maintenance target apparatus, inputs information into the terminal information for specifying/identifying the maintenance/service work to be performed at the worksite for the maintenance target apparatus. Then, the terminal 200 indicates, on a display screen or the like, which items (tools or components) should be loaded/included in the engineer's toolbox 600 for the planned work are stored, or indicates a specific toolbox 600 that already includes the appropriate items for the planned work. In such a case, the engineer takes out the particular toolbox 600 from a warehouse and then causes the RFID reader 400 to read the toolbox 600.

The RFID reader 400 reads ID information from the RFID tags 611, 621, and 631 attached to the items 610, 620, and 630 in the toolbox 600 and outputs the ID information to the terminal 200. The terminal 200 collates the ID information with a list of ID information of the RFID tags 611, 621, and 631 accompanying the items 610, 620, and 630 that should be present in the toolbox 600. If there is shortage or inconsistency, the terminal 200 indicates to the engineer that there is a shortage or an inconsistency with, for example, a display on the screen.

The terminal 200 records, in the server 300, information indicating that the particular items 610, 620, and 630 corresponding to the ID information read by the RFID reader 400 are being taken out.

If the engineer adds another item (tool or component) 690 to, or with, the toolbox 600, the terminal 200 records in the server 300, information indicating that the engineer also carries the item 690 for performing the planned work. ID information stored by an RFID tag 691 stuck to, or otherwise associated with, the item 690 is used to establish the record for the inclusion of item 690.

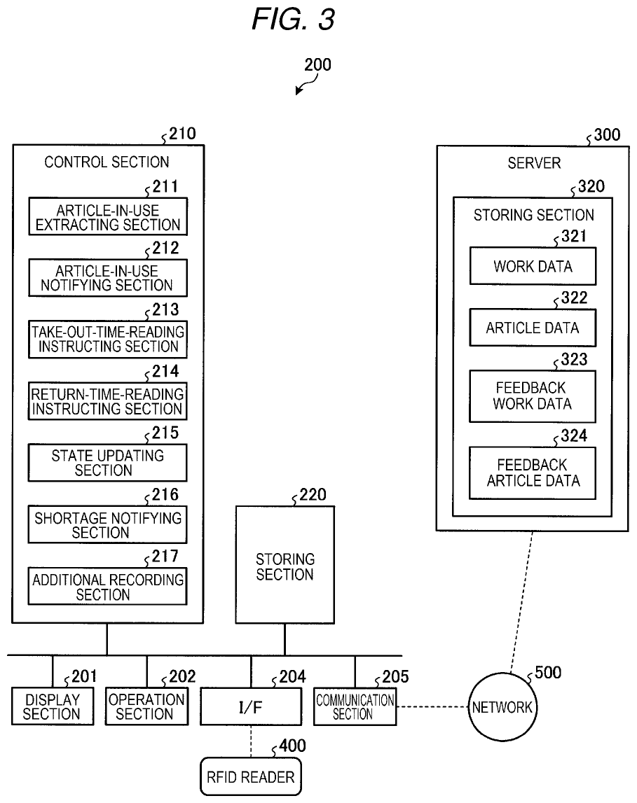

FIG. 3 is a block diagram illustrating the configurations of the terminal 200 and the server 300. The terminal 200 includes a display section 201, an operation section 202, an interface (I/F) 204, a communication section 205, a control section 210, and a storing section 220. The server 300 includes a storing section 320.

The display section 201 is an example of an output section that notifies information to the operator and can be a display device such as a liquid crystal display. In this context, an output section may also or instead be another information output device such as a printer or a speaker. The operation section 202 is an example of an input section that receives operator inputs for designating work from the operator and is, for example, a keyboard and a mouse or a touch panel that is provided over the display section 201 and receives operation according to displayed content on the display section 201 (e.g., a graphical user interface).

The I/F 204 connects the RFID reader 400 to the terminal 200 and transmits an output of the RFID reader 400 to the control section 210. The communication section 205 connects the terminal 200 to the network 500 and enables the server 300 and the control section 210 to communicate via the network 500.

The control section 210 is a computer type component and can be configured as a CPU (Central Processing Unit), a ROM (Read Only Memory), a RAM (Random Access Memory), and the like. The ROM is a storage medium that stores various computer programs and data. The RAM is a storage medium that temporarily stores various computer programs and various data. The CPU functions by executing computer programs stored in the ROM or the like and collectively controls the operation of the terminal 200.

The storing section 220 is a storage device such as a HDD (Hard Disk Drive) or an SSD (Solid State Drive). The storing section 220 stores various computer programs executable by the control section 210, setting parameters, and the like.

The storing section 320 of the server 300 is also a storage device such as a HDD (Hard Disk Drive) or an SSD (Solid State Drive). The storing section 320 includes a work-data storing section 321, an article-data storing section 322, a feedback-work-data storing section 323, and a feedback-article-data storing section 324.

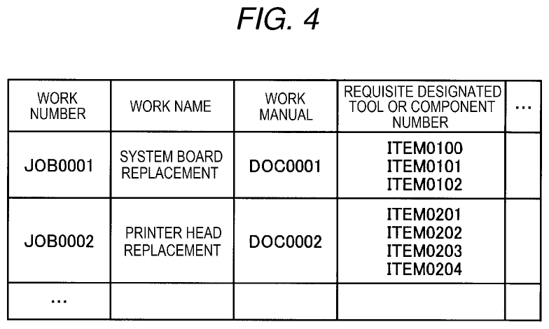

The work-data storing section 321 stores work data. FIG. 4 is a diagram illustrating content of the work data. As an example, the work data in this embodiment is stored in the work-data storing section 321 in a format of a table. Columns forming the work data indicate, for example, a work type number (“work number”), a work name, a work manual identifier (“work manual”), and a requisite designated tool or component number (s) (“requisite designated tool or component number”).

The work type number is an example of work information, which is information capable of specifying work to be performed by the engineer. The work type number is a code of predetermined digits of numbers, letters, or the like allocated to the different kinds of work the engineer may perform. The work name is text or characters more plainly representing content of the work such as “system board replacement” or “printer head replacement” corresponding to the coded work type number. The work manual identifier is a code for specifying a document for explaining the procedures associated with the work to be performed by the engineer. The requisite designated tool or component number(s) specify particular tools and components that are considered necessary for the planned work. In the work data, one or more requisite designated tool or component numbers are associated with each work type number.

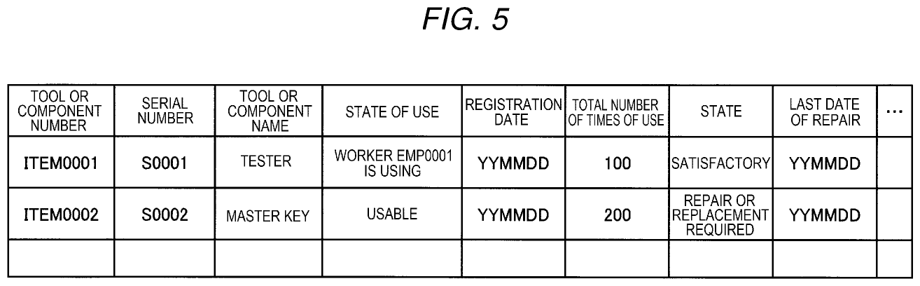

The article-data storing section 322 stores article (tool or component) data. FIG. 5 is a diagram illustrating content of the article data. As an example, the article data in this embodiment is stored in the article-data storing section 322 in a format of a table. Columns forming the article data indicate, for example, a tool or component number, a serial number, a tool or component name, a state of use, a registration date, a total number of times of use, a state (condition), and a last date of repair.

The tool or component number is an example of article information. The tool or component number is information capable of specifying a tool and a component by at least type. The tool or component number is formed by predetermined digits of numbers, alphabets, and the like and respectively allocated to kinds of tools and components to be used in the various possible work of the service engineer. The serial number is ID information stored in an RFID tag accompanying a particular tool or the component. The tool or component name is a common name for the tool or the component such as “tester” or “master key”.

The state of use is an example of state information capable of discriminating whether an article has been returned to its predetermined storage place. The state of use indicates whether the article has been checked out by the engineer and is thus unavailable for use or whether the article is currently present in a warehouse and is thus useable. The registration date is a date on which the particular tool or the component was initially added to the article-data storing section 322. The total number of times of use indicates the number of times the particular tool or the component has been checked out/used. The state entry is for indicating a present condition of the tool or the component such as “satisfactory” or “repair or replacement required”. The last date of repair is the date when the tool or the component was last repaired.

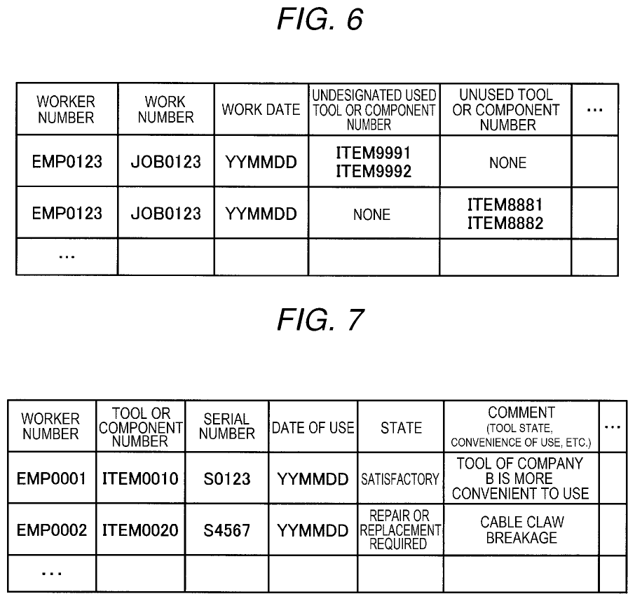

The feedback-work-data storing section 323 stores feedback work data. FIG. 6 is a diagram illustrating content of the feedback work data. As an example, the feedback work data in this embodiment is stored in the feedback-work-data storing section 323 in a format of a table. Columns forming the feedback work data indicate, for example, a worker number, a work number, a work date, an undesignated used tool or component number, an unused tool or component number.

The worker number specifies the particular engineer who performs the work. In this embodiment, the worker number is a user ID of the engineer presently logged in to the terminal 200. The “work number” entry is the same as the work type number (“work number”) in the work data illustrated in FIG. 4 and is a number capable of identifying the particular work that has been performed. The work date is a date when the work was performed. Each record in the feedback work data is includes the worker number, the work type number, and the work date.

The undesignated used tool or component number is an example of additional use information, which is information concerning articles that were used in the work other than those articles particularly associated with work information in the work-data storing section 321 beforehand. Thus, the undesignated used tool or component number reflects the tool or components (by tool or component number) that were not included in the requisite designated tool or component number associated with the work type number (illustrated in FIG. 4), but which were used by the engineer in performing the work associated with the work type number.

The unused tool or component number is an example of nonuse information, which is information concerning articles associated with the work type number in the work information in the work-data storing section 321, but which were not actually used in the work performed by the engineer. The unused tool or component number reflects the article(s) (by tool or component number) that were not used by the engineer in performing the work even though listed among the articles in the requisite designated tool or component number of the work data as illustrated in FIG. 4.

The feedback-article-data storing section 324 stores feedback article data. FIG. 7 is a diagram illustrating the feedback article data. As an example, the feedback article data in this embodiment is stored in the feedback-article-data storing section 324 in a format of a table. Columns forming the feedback article data indicate, for example, a worker number, a tool or component number, a serial number, a date of use, a state, and a comment.

The worker number is a number (a user ID) capable of specifying an engineer who inputs the data. The tool or component number is a number for specifying a particular tool or a component by type. The serial number is ID information stored in an RFID tag accompanying the particular tool or the component of concern. The date of use is a date when the engineer used the tool or the component. Each record of the feedback article data includes the worker number, the serial number, and the date of use.

In this context the “state” column entry is an example of additional information concerning an article and is information for notifying a present condition of the tool or the component (whether the article is in a state requiring maintenance) such as “satisfactory” or “repair or replacement required”. The comment is another example of the additional information concerning the particular article and is, for example, an opinion or a comment concerning the tool or the component input by the engineer after working with the tool or component. The comment may relate to tool/component condition and/or an evaluation of the convenience of use of the tool or the like.

Referring back to FIG. 3, the CPU reads out and executes computer programs stored in the storing section 220 and the ROM, whereby the control section 210 of the terminal 200 realizes various functional sections. The control section 210 includes, as the functional sections, an article-in-use extracting section 211, an article-in-use notifying section 212, a take-out-time-reading instructing section 213, a return-time-reading instructing section 214, a state updating section 215, a shortage notifying section 216, and an additional recording section 217.

The article-in-use extracting section 211 receives input for designating the work to be performed from the engineer via the operation section 202 and extracts, from the article-data storing section 322, requisite designated tool or component numbers (article information) associated with a work number (work information) corresponding to the input. The article-in-use notifying section 212 indicates information corresponding to the requisite designated tool or component numbers extracted by the article-in-use extracting section 211. More specifically, the article-in-use notifying section 212 displays, for example, on the display section 201, the requisite designated tool or component numbers, names of these articles, and the like, for example, as a list.

The take-out-time-reading instructing section 213 instructs the operator (in this context, the engineer), for example, via the display section 201, to cause the RFID reader 400 to read RFID tags attached to those articles specified by the article information indicated by the article-in-use notifying section 212.

The return-time-reading instructing section 214 instructs the operator (in this context, the engineer), for example, via the display section 201, to cause the RFID reader 400 to read RFID tags attached to articles when returning the articles to a storage place (e.g., a warehouse or central office).

The state updating section 215 updates, according to whether the reading is after the instruction by the take-out-time-reading instructing section 213 or after the instruction by the return-time-reading instructing section 214, a state of use (state information) corresponding to serial numbers (ID numbers) read by the RFID reader 400 to a state indicating that the article is being taken out or a state indicating that is returned.

That is, if the reading by the RFID reader 400 is performed after the instruction by the take-out-time-reading instructing section 213, the state updating section 215 updates a state of use in article data corresponding to the read serial numbers to a state of use including a number (a worker number) for specifying an engineer taking out the article and description such as “in use”.

If the reading by the RFID reader 400 is performed after the instruction by the return-time-reading instructing section 214, the state updating section 215 updates the state of use in the article data corresponding to the read serial numbers to, for example, “usable” or “returned”.

The shortage notifying section 216 indicates there is a shortage if the serial numbers read by the RFID reader 400 do not include serial numbers corresponding to all the tool or component numbers extracted by the article-in-use extracting section 211.

The shortage notifying section 216 also indicates there is a shortage if the serial numbers read by the RFID reader 400 at return time do not include all of the serial numbers of the tools or components taken out initially.

The additional recording section 217 updates the feedback-work-data storing section 323 when articles are taken out. That is, the additional recording section 217 records, as feedback work data, an indication to the effect that the engineer did or did not carry, for the work, any undesignated articles. Further, the additional recording section 217 records, as feedback work data, an indication to the effect that the engineer did or did not carry, for the work, any unused articles among the articles corresponding to the serial numbers read by the RFID reader 400 and particularly designated by the work data.

The additional recording section 217 updates the feedback-article-data storing section 324 according to inputs on the operation section 202 when articles are returned. That is, the additional recording section 217 records, as feedback article data, information (states (satisfactory and repair and replacement required) and comments (tool states, convenience of use, etc.)) concerning articles corresponding to the serial numbers read by the RFID reader 400.

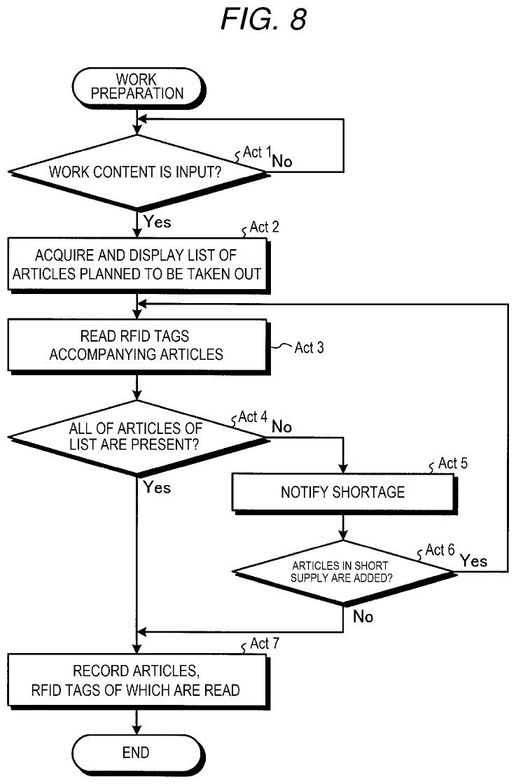

FIG. 8 is a flowchart illustrating a flow of work preparation processing executed by the control section 210. This processing is executed when an engineer is about to go offsite to service a maintenance target apparatus and is gathering tools and components to be carried for the particular work. The control section 210 provides a UI for receiving a designation of the work to be performed by an operator logged in to the terminal 200 (i.e., an engineer who is a worker that will be performing work) and receives designation of the work (work content) to be performed via the UI (Act 1).

The engineer may designate work via the operation section 202 using a keyword associated with content of the work about to be performed, the UI may provide a list of work names, on the display section 201, matching the keyword that has been retrieved and/or extracted from the work-data storing section 321. The engineer/operator may then select a work name from the list using the operation section 202.

In Act 1, the control section 210 stands by (No in Act 1) for an input of work content. If work content is input in Act 1 (Yes in Act 1), the control section 210 advances the processing to Act 2, acquires (via the article-in-use extracting section 211) a list of articles planned to be taken out and displays (via the article-in-use notifying section 212) the list. At the same time, the control section 210 instructs (via the take-out-time-reading instructing section 213) the engineer to place the articles shown in the list on the RFID reader 400.

Subsequently, the control section 210 advances the processing to Act 3 and reads the RFID tags 611, 621, and 631 accompanying the items 610, 620, and 630 using the RFID reader 400. This is executed by, for example, placing the toolbox 600 on the RFID reader 400, for example, as illustrated in FIG. 2.

Subsequently, the control section 210 advances the processing to Act 4 and determines whether all of the articles of the list are present. If not all of the articles of the list are present (No in Act 4), the control section 210 advances the processing to Act 5 and indicates (via the shortage notifying section 216) the shortage to the engineer via the display section 201. In indicating the shortage, the control section 210 may cause the display section 201 to display the missing articles as a new list or may process the list displayed in Act 2 (e.g., color-code the list or add highlighting/symbols to the list).

Subsequently, the control section 210 asks the engineer whether the missing articles have been added (Act 6). If the engineer replies in Act 6 using the operation section 202 that the missing (or short supplied) articles have been added (Yes in Act 6), the control section 210 returns the processing to Act 3.

In Act 6, if the missing articles are considered unnecessary by the engineer, the engineer can also reply by using the operation section 202 that the missing articles will not be added. In that case (No in Act 6), the control section 210 advance the processing to Act 7. Likewise, if all the articles of the list are present in Act 4 (Yes in Act 4), the control section 210 also advances the processing to Act 7.

In Act 7, the control section 210 updates the article-data storing section 322 and updates a state of use in article data corresponding to the serial numbers read in Act 3 to a state of use including a user ID (a worker number) and description such as “in use” (via the state updating section 215). Alternatively, for convenience, the control section 210 may determine with only the description of the user ID that the article data is in use. The article data to be updated does not always coincide with the article data in the list displayed in Act 2 and can be more or less than the article data in the list according to those articles actually taken out from the warehouse.

Further, in Act 7, the control section 210 functions as the additional recording section 217 and updates the feedback-work-data storing section 323. That is, the control section 210 adds, to the feedback-work-data storing section 323, a record indicating to the effect, according to reading of RFID tags in Act 3, that the engineer did or did not carry all the listed items for the planned work and/or whether the engineer did or did not carry any additional items not included in the item listing (generated in Act 2) for the planned work.

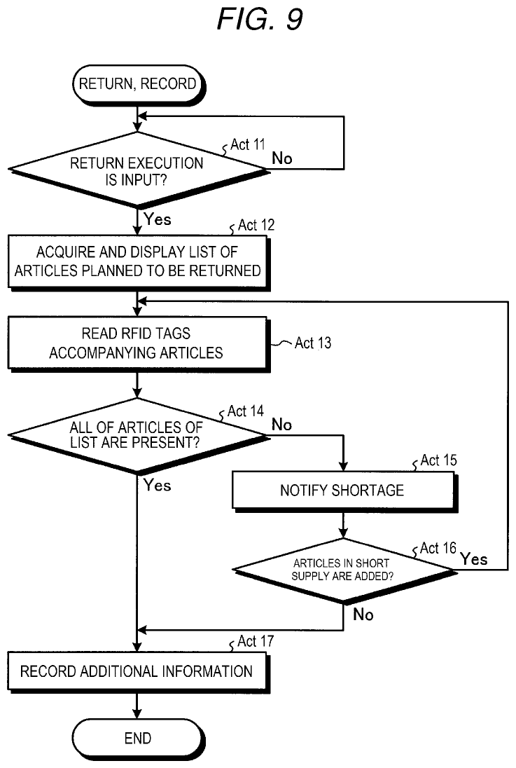

FIG. 9 is a flowchart illustrating a flow of return and recording processing executed by the control section 210. This processing is executed when the engineer returns to the central office from a worksite and returns the tools and/or components checked out for the work. The control section 210 provides, to a logged in operator of the terminal 200 (i.e., the engineer who is the worker performing the work), a UI for receiving input(s) for declaring the return of articles and receives this operator input via the UI (Act 11).

As the UI in Act 11, for example a button for receiving an input for declaring that return of articles can be provided as an option in a common startup screen or the like also used with Act 1 (in FIG. 8).

In Act 11, the control section 210 stands by (No in Act 11) for input. If a declaration of return of articles is input in Act 11 (Yes in Act 11), the control section 210 advances the processing to Act 12, acquires a list of articles that should be returned, and displays the list. Articles to be displayed in the list can be acquired by extracting records including a user ID of the engineer from the article-data storing section 322. The control section 210 instructs (via the return-time-reading instructing section 214), in addition to the list display, the engineer to place the articles shown in the list on the RFID reader 400.

Subsequently, the control section 210 advances the processing to Act 13 and reads, with the RFID reader 400, the RFID tags 611, 621, and 631 accompanying the items 610, 620, and 630. This is executed by placing the toolbox 600 on the RFID reader 400, for example, as illustrated in FIG. 2.

Subsequently, the control section 210 advances the processing to Act 14 and determines whether all of the articles of the list are present. If not all of the articles of the list are present (No in Act 14), the control section 210 advances the processing to Act 15 and indicates a shortage to the engineer via the display section 201 (the shortage notifying section 216). In indicating the shortage, the control section 210 may cause the display section 201 to display articles in short supply (missing articles) as a list or may process the list displayed in Act 12 (e.g., color-code the list, add symbols to the list text, or highlighting to the list).

Subsequently, the control section 210 ask the engineer whether the missing (short) articles have been added (Act 16). If the engineer replies in Act 16 using the operation section 202 that the articles in short supply have been added (Yes in Act 16), the control section 210 returns the processing to Act 13.

In Act 16, if the engineer does not return the missing (short) articles, the engineer can reply that the missing (short) articles will not be added. In that case (No in Act 16), the control section 210 advances the processing to Act 17. If all the articles of the list are present in Act 14 (Yes in Act 14), the control section 210 also advances the processing to Act 17.

In Act 17, the control section 210 updates a state of use of article data corresponding to the serial numbers read in Act 13 to “usable”, “returned”, or the like (the state updating section 215). The article data to be updated does not always coincide with the article data in the list displayed in Act 12 and can be more or less than the article data in the list according to the articles actually returned to the warehouse.

Further, in Act 17, the control section 210 functions as the additional recording section 217 and updates the feedback-article-data storing section 324 according to input on the operation section 202. That is, the control section 210 adds, to the feedback-article-data storing section 324, a record including additional information concerning articles corresponding to the serial numbers read by the RFID reader 400 in Act 13. Examples of the additional information include a state (satisfactory and repair and replacement required) of tools and a comment (a specific state, convenience of use, etc.) concerning tools and components.

If information to the effect that repair or replacement is necessary is recorded in Act 17, the control section 210 can quickly send the information to a predetermined department or the like. Further, the control section 210 reflects the “state” (see FIG. 7) of the feedback-article-data storing section 324 on the “state” (see FIG. 5) of the article-data storing section 322. If information concerning convenience of use is recorded, the control section 210 enables the record to be referred to in, for example, the list display in Act 2.

With such a configuration, when going to a maintenance service, first, the engineer operates the operation section 202 of the terminal 200 and logs in to the terminal 200. Then, the terminal 200 causes the display section 201 to display a UI. Therefore, the engineer inputs, using the UI, work to be performed for maintenance of an offsite apparatus. Then, the terminal 200 displays a list of articles and causes or requests the RFID reader 400 to read RFID tags. In response to this, the engineer places items (e.g., the toolbox 600 and the article 690) taken out from the warehouse on or otherwise proximate to the RFID reader 400. If not all of the listed articles for the work to be performed are present, the terminal 200 notifies the engineer that there are missing articles remaining from the list. The engineer the either adds the missing articles or indicates the missing articles are unnecessary and proceeds. The terminal 200 records in the server 300 that the engineer carries those articles recognized/read by the RFID reader 400.

When returning from the maintenance service call/visit, the engineer again operates the operation section 202 of the terminal 200 and logs in to the terminal 200. The terminal 200 determines from the records stored in the server 300 whether the logging-in engineer has previously taken out articles yet to be returned. If the engineer has taken out articles, the terminal 200 includes a button in the UI displayed on the display section 201 for starting an article return process. If the button is operated, the terminal 200 displays a list of the articles that were taken out by the engineer and causes the RFID reader 400 to read RFID tags. In response to this, the engineer places the returned articles (e.g., the toolbox 600 and the article 690) on the RFID reader 400. If not all of the articles of the checkout list are present according to the reading of the RFID reader 400, the terminal 200 indicates there are missing (unreturned) articles to the engineer. The engineer either adds the missing articles, if possible, or indicates via the operation section 202 that the missing articles cannot be returned (for example, the checked out article is faulty, broken, or was left at the maintenance worksite). The engineer records, in the server 300, additional information concerning the articles there were carried for the maintenance.

As explained above, according to this embodiment, it is possible to easily confirm whether items, such as tools and components, to be used for offsite work are packed before leaving for the worksite. For those articles that are intentionally not carried, it is possible to record to that these articles were not checked out. If articles which are not on a pre-established packing list/manifest are actually checked out be the service engineer and carried to the worksite, it is possible to record that these additional articles are considered appropriate by the engineer to be carried for the work.

Further, according to this embodiment, it is possible to record that carried articles are returned. It is also possible to record articles that were carried but not returned. Further, it is possible to record additional information concerning the checked out articles. It is possible to refer to these records for future work.

Tools are sometimes faulty or broken and need to be repaired or replaced. It is possible to readily share such information upon article return. Since each article is recorded when returned, it is possible record tool condition states, conditions, comments while the memory of the engineer is fresh. It is possible to reduce omissions of relevant information from the records.

In this example embodiment, in general, the toolbox 600 is not a particular inventory management target. The RFID tags are placed on individual articles stored in the toolbox 600 and information is tracked for the individually tagged items rather than for a toolbox 600 itself. However, in other examples, the toolbox 600 may be RFID tagged and its checkout, return, condition, etc. maybe tracked in a manner similar to the individually tagged items described above. The toolbox 600 may be tagged in lieu of or in addition to the tagging of individual items (e.g., items 610, 620, and 630)

In this embodiment, for convenience of explanation, the RFID reader 400 is illustrated in FIG. 2 as having a shape on which the toolbox 600 can be placed. However, the RFID reader 400 may have any form. For example, the RFID reader 400 may be a box into which tagged items are placed or a handheld type.

Modification

In a modification of the above example, the storing section 320 of the server 300 includes a use-history storing section that store a use history. The use history is an operation history of article information in time series. The use history may be presented as a summary of tool or component usage over time.

The control section 210 of the terminal 200 additionally includes a shortage predicting section. The shortage predicting section refers to the operation history stored by the use-history storing section and predicts whether the number of articles of the same type (e.g., having the same tool or component number) in use will exceed the total available number of articles of the relevant type in stock. When the predicted number of simultaneously operated articles of a same type exceeds the number in stock, the shortage predicting section causes the display section 201 of the terminal 200 to display a message or indication to that effect and urges the engineer or other operator to supply or return those articles with a predicted shortage.

According to such a modification, operation states of frequently used articles can be grasped. Therefore, it is possible to prevent inconvenience that occurs when the engineer needs to use a certain article, but the article is unavailable or out of stock.

The article management system 100 according to this embodiment includes a control device such as a CPU, storage devices such as a ROM (Read Only Memory) and a RAM, external storage devices such as a HDD and a CD drive device, a display device such as a display, and input devices such as a keyboard and a mouse. The article management system 100 in an example has a hardware configuration that makes use of a standard computer.

Computer programs executed in the article management system 100 according to this embodiment are non-transitorily recorded in a computer-readable recording medium such as a CD-ROM, a flexible disk (FD), a CD-R, or a DVD (Digital Versatile Disk) as a file in an installable form or an executable form.

The computer programs executed in the article management system 100 may be stored on a computer connected to a network such as the Internet and provided by being downloaded through the network. The computer programs executed in the article management system 100 may be provided or distributed through the network such as the Internet.

The computer programs in this embodiment may be incorporated in a ROM or the like.

The computer programs executed in the article management system 100 have a modular configuration including those sections explained above (the article-in-use extracting section 211, the article-in-use notifying section 212, the take-out-time-reading instructing section 213, the return-time-reading instructing section 214, the state updating section 215, the shortage notifying section 216, and the additional recording section 217). The processor (CPU) reads out the computer programs from the storage devices and executes the computer programs to thereby load the sections onto a main memory or the like. Consequently, the article-in-use extracting section 211, the article-in-use notifying section 212, the take-out-time-reading instructing section 213, the return-time-reading instructing section 214, the state updating section 215, the shortage notifying section 216, and the additional recording section 217 are implemented on the main memory or the like.

While several example embodiments are explained above, the embodiments of the present disclosure are not limited to these examples. The presented examples and do not limit the scope of the present disclosure. Indeed, embodiments of the present disclosure can be implemented in other various forms. That is, various omissions, substitutions, and changes to the examples can be made without departing from the spirit of the present disclosure. Such embodiments, variations, and modifications are to be considered as included in the scope and the gist of the present disclosure, which is reflected in the accompanying claims and equivalents of thereof.

What is claimed is:

1. An item management system, comprising:
a user terminal including a controller;
a reader connected to the user terminal and configured to read ID information from a wireless tag and supply the ID information to the user terminal; and
a storage unit storing:
item information in association with ID information of wireless tags on items being managed, and
an item listing for a work type;
wherein
the controller is configured to:
store the ID information read from the wireless tag in the storage unit, the ID information being associated with an item to which the wireless tag is attached, and then update state information indicating whether the item is at a predetermined storage place or has been checked out by a user;
receive a designation of a work type from the user;
extract, from the storage unit, the item listing corresponding to the designated work type;
control a display to display information corresponding to the extracted item listing and an instruction to the user to use the reader to read wireless tags attached to items in the extracted item listing;
update the item information in the storage unit for any item associated with ID information from wireless tags read by the reader to indicate the items are checked out or returned; and
indicate, via the display, that at least one item from the extracted item listing has not been checked out or returned by the user by reference to the ID information read by the reader.

2. The system according to claim 1, wherein the processor is further configured to store, in the storage unit, user feedback information on items that have been returned by the user.

3. The system according to claim 2, wherein the feedback information indicates a condition of an item returned by the user.

4. The system according to claim 2, wherein the feedback information indicates whether an item on the extracted listing was necessary for work of the designated work type.

5. The system according to claim 1, wherein
the storage unit stores an operation history in time series for the items being managed, and
the controller is further configured to predict whether a required number of items for scheduled work will exceed a total number of the items in stock.

6. An item management method, comprising:
storing item information in association with ID information of wireless tags on items being managed;
storing an item listing for a work type;
receiving a designation of the work type from a user;
extracting the stored item listing for the designated work type;
controlling a display to display information corresponding to the extracted item listing and an instruction for a user to use a reader to read wireless tags attached to items in the extracted item listing;
reading ID information from a wireless tag, the ID information being associated with an item to which the wireless tag is attached;
updating state information for the item to which the wireless tag is attached to indicate whether the item is at a predetermined storage place or has been checked out by the user;
comparing the item listing to the ID information read by the reader; and
indicating, via the display, that at least one item from the extracted item listing has not been checked out by the user by reference to the comparison of the item listing to the ID information read by the reader.

7. The method according to claim 6, further comprising:
storing user feedback information on items that have been returned by the user.

8. The method according to claim 7, wherein the feedback information indicates a condition of an item as returned by the user.

9. The method according to claim 7, wherein the feedback information indicates whether an item on the extracted listing was necessary for the work of the designated work type.

10. The method according to claim 6, further comprising:
storing an operation history in time series for items being managed.

11. The method according to claim 10, further comprising:
comparing a required number of items for a plurality of scheduled work to a total number the items in stock; and
indicating a shortage of items in stock is possible based on the stored operation history of items.

12. The method according to claim 6, further comprising:
comparing a required number of items for a plurality of scheduled work to a total number the items in stock.

13. The method according to claim 6, further comprising:
tracking a condition of each item being managed.

14. The method according to claim 6, further comprising:
tracking whether the user takes additional items beyond those listed on the item listing for the designated work type.

15. The method according to claim 6, further comprising:
tracking whether the user takes fewer items than listed on the item listing for the designated work type.

16. The method according to claim 15, further comprising:
tracking whether each item checked out by the user has been returned.

17. The method according to claim 6, further comprising:
tracking whether each item checked out by the user has been returned.

18. An article management method for an article management system including a reader configured to read ID information from a wireless tag storing the ID information, an article-data storing section configured to store, in association with article information, which is information capable of specifying an article, the ID information of the wireless tag attached to the article and state information capable of discriminating whether the article is returned to a predetermined storage place, and a work-data storing section storing, in association with work information, which is information capable of specifying work, the article information of one or more articles used for the work,
the article management method comprising:
extracting, from the article-data storing section, the article information associated with the work information corresponding to the designation operation by the operator;
notifying information corresponding to the article information extracted by the article-in-use extracting section to the operator;
instructing the operator to cause the reader to read the wireless tag attached to the article specified by the article information notified by the article-in-use notifying section;
instructing the operator to cause the reader to read the wireless tag attached to the article when returning the article to the storage place;
updating, according to whether the reading is after the instruction by the take-out-time-reading instructing section or after the instruction by the return-time-reading instructing section, the state information corresponding to the ID information read by the reader to the state information indicating that the article is being taken out or the state information indicating that the article is returned; and
notifying shortage if the ID information read by the reader according to the instruction by the take-out-time-reading instructing section includes not all of the ID information corresponding to the article information extracted by the article-in-use extracting section and notify shortage if the ID information read by the reader according to the instruction by the return-time-reading instructing section includes not all of the ID information read by the reader according to the instruction by the take-out-time-reading instructing section.
